(19) United States
(12) Patent Application Publication
(10) Pub. No.: US 2025/0144452 A1
(43) Pub. Date: May 8, 2025

(54) DUAL GASKET FOR USE WITH FACE MASKS

(71) Applicant: Christopher J. Leger, Mount Holly, NJ (US)

(72) Inventor: Christopher J. Leger, Mount Holly, NJ (US)

(21) Appl. No.: 19/018,353

(22) Filed: Jan. 13, 2025

Related U.S. Application Data
(63) Continuation-in-part of application No. 17/352,735, filed on Jun. 21, 2021.

(51) Int. Cl. A62B 18/02; A62B 18/08

(52) U.S. Cl. CPC A62B 18/02; A62B 18/08

(57) ABSTRACT

A gasket apparatus, comprising an inner gasket portion configured to form an airtight seal with a substrate, wherein the substrate is a human face; an outer gasket portion formed partially or completely around the inner gasket portion; and an interstitial space formed between the inner gasket portion and the outer gasket portion, wherein the interstitial space is configured to receive a portion of a protective item therein.

### CROSS-REFERENCE TO RELATED APPLICATIONS

This patent application is a continuation-in-part of U.S. patent application Ser. No. 17/352,735 filed on Dec. 21, 2021 and entitled “Dual Gasket For Use With Face Masks”, the disclosure of which is hereby incorporated by reference herein in its entirety and made part of the present U.S. utility patent application for all purposes.

### BACKGROUND

The disclosed inventive subject matter relates in general to a protective equipment used in hazardous environments, and more specifically to a modified face piece or face mask gasket for use with breathing systems and devices used in firefighting and for other purposes.

A self-contained breathing apparatus (SCBA), also referred to as a compressed air breathing apparatus (CABA) or simply breathing apparatus (BA), is a wearable system and/or device that provides breathable air in atmospheres or environments that are immediately dangerous to human life or human health. The term “self-contained” indicates that an SCBA is not dependent on a remote supply of breathing gas (e.g., through a length of hose). If designed for use under water, such systems are referred to as self-contained underwater breathing apparatuses (SCUBA). When not used underwater, these systems are sometimes referred to as industrial breathing sets, air packs, air tanks or simply packs, which are primarily used for firefighting. An SCBA typically includes three primary components: (i) a high-pressure gas tank; (ii) a pressure regulator, and (iii) an inhalation device (e.g., mouth mask, face mask, or face piece), connected to one another and mounted on a carrying frame. A flame-resistant hood or similar device may be attached to the face mask to provide further protection to the wearer of the SCBA. Such systems are typically used for firefighting and industrial applications, although medical applications have recently become relevant. For example, the American National Institutes of Health prescribe the use of SCBAs for medical staff during treatment of Ebola and other dangerous pathogens.

An SCBA is typically an open-circuit system or in the case of a SCUBA, either an open-circuit system or closed-circuit system. A closed-circuit system, also known as a rebreather, operates by filtering, supplementing, and recirculating exhaled gas and is used when a longer-duration supply of breathing gas is needed, such as in mine rescue or operation in passages that are too narrow to accommodate the large gas cylinders used with open-circuit systems. Open-circuit industrial breathing sets are filled with filtered, compressed air, rather than pure oxygen. Typical open-circuit systems have two regulators: (i) a first stage regulator for reducing the pressure of air to allow it to be carried to the face mask, and (ii) a second stage regulator to further reduce air pressure to a level just above standard atmospheric pressure. This air is then fed to the face mask by a demand valve (activating only on inhalation) or a continuous positive pressure valve (providing constant airflow to the mask). An open-circuit rescue or firefighter SCBA typically includes a full-face mask, regulator, air cylinder, cylinder pressure gauge, remote pressure gauge, and a harness with adjustable shoulder straps and waist belt which allows the system to be worn on the back.

Open circuit SCBAs operate using either positive pressure or negative pressure. A negative pressure system relies on the internal pressure of the face mask dropping to below the ambient pressure to activate gas flow. If the mask does not seal properly, some leakage of ambient air into the mask will occur, which can be very problematic in environments containing toxic gases or irritant smoke and fumes. A positive pressure system slightly pressurizes the interior of the face mask and activates gas flow when the internal pressure is reduced, but is still above ambient pressure. If the face mask leaks, continuous gas flow maintains the internal pressure, and no inward leakage will occur. When the face mask fits correctly and seals properly around the face of the wearer, this design is economical with regard to the amount of breathing gas used and prevents contamination from the outside environment. Although the performance of both types of SCBA systems may be similar under optimum conditions, this “fail safe” aspect of a positive pressure SCBA makes it preferable for most applications.

As indicated above, the quality of the seal formed by the face mask in an SCBA is an important aspect of system performance. In most SCBAs used for firefighting, the seal at the edge of the face mask includes a wide tube-like structure having thin, flexible walls around the periphery of the face mask, filled with air at atmospheric pressure. On the surface, the seal pushes against the edges of the wearer's face, creating a tight seal despite small variations in head shape. Maintaining the integrity of this seal is critical with regard to proper functioning of the face mask and entire SCBA system. However, because the sealing portion of many face masks include snaps, tabs, buckles, and other connectors for attaching protective hoods or other items to the face mask, the seal can be reduced or even broken when the face mask is in use, thereby potentially creating serious problems for the wearer. Accordingly, there is an ongoing need for a face mask for use with SCBA systems that includes an improved gasket apparatus for attaching protective items near the sealing portion of the face mask without negatively affecting the quality of the seal formed between the face mask and face of the wearer of the SCBA system.

### SUMMARY

The following provides a summary of certain example implementations of the disclosed inventive subject matter. This summary is not an extensive overview and is not intended to identify key or critical aspects or elements of the disclosed inventive subject matter or to delineate its scope. However, it is to be understood that the use of indefinite articles in the language used to describe and claim the disclosed inventive subject matter is not intended in any way to limit the described inventive subject matter. Rather the use of “a” or “an” should be interpreted to mean “at least one” or “one or more”.

One implementation provides a gasket apparatus, comprising an inner gasket portion configured to form an airtight seal with a substrate, wherein the substrate is a human face; an outer gasket portion formed partially or completely around the inner gasket portion; and an interstitial space formed between the inner gasket portion and the outer gasket portion, wherein the interstitial space is configured to receive a portion of a protective item therein.

The outer gasket portion may include at least one type of connecting device thereon for connecting the portion of the protective item to the outer gasket portion within the interstitial space without disrupting the airtight seal formed by the inner gasket portion. The at least one type of connective device on the outer gasket portion may include snaps, buttons, buckles, rivets, hooks and loop connectors, or combinations thereof. The protective item may include a hood, a helmet, a head covering, or the like. The inner gasket portion and the outer gasket portion may be formed integrally with one another from a single piece of material. The inner gasket portion may include at least one type of connector device formed thereon or attached thereto. The at least one type of connector apparatus on the inner gasket portion may receive a head net or a head harness of the protective item. The at least one type of connector apparatus on the inner gasket portion may be a gasket tab. In one or more implementations, the gasket apparatus may be adapted for use with a self-contained breathing apparatus. The self-contained breathing apparatus may be adapted for use in industrial environments, commercial environments, household environments, firefighting environments, biohazard environments, medical environments, or military environments. The interstitial space may be substantially V-shaped in some non-limiting implementations.

Another implementation provides a gasket apparatus, comprising an inner sealing gasket portion configured to form an airtight seal with a substrate, wherein the substrate is a human face; an outer flexible gasket portion formed partially or completely around the inner sealing gasket portion, wherein the outer flexible gasket portion includes at least one type of connecting device thereon; and an interstitial space formed between the inner sealing gasket portion and the outer flexible gasket portion, wherein the at least one type of connecting device connects one or more protective items to the outer flexible gasket portion within the interstitial space without disrupting the airtight seal formed by the inner sealing gasket portion.

The at least one type of connective device on the outer flexible gasket portion may include snaps, buttons, buckles, rivets, hooks and loop connectors, or combinations thereof. The one or more protective items may include a hood, a helmet, a head covering, or the like. The inner sealing gasket portion and the outer flexible gasket portion may be formed integrally with one another from a single piece of material. The inner sealing gasket portion may include at least one gasket tab formed thereon or attached thereto, and the at least one gasket tab may receive a head net or a head harness of the one or more protective items. The gasket apparatus may be adapted for use with a self-contained breathing apparatus, and the self-contained breathing apparatus may be adapted for use in industrial environments, commercial environments, household environments, firefighting environments, biohazard environments, medical environments, or military environments. In some non-limiting implementations, the interstitial space is substantially V-shaped.

Still another implementation provides a gasket apparatus for use with a self-contained breathing system or apparatus, comprising an inner sealing gasket portion configured to form an airtight seal with a substrate, wherein the substrate is a human face, and wherein the inner sealing gasket includes at least one type of connector apparatus formed thereon or attached thereto; an outer flexible gasket portion formed partially or completely around the inner sealing gasket portion, wherein the outer flexible gasket portion includes at least one type of connecting device thereon; and an interstitial space formed between the inner sealing gasket portion and the outer flexible gasket portion, wherein the at least one type of connecting device connects a portion of a protective hood to the outer flexible gasket portion within the interstitial space without disrupting the airtight seal formed by the inner sealing gasket portion, and wherein the at least one type of connector apparatus on the inner sealing gasket portion receives a head net or a head harness of the protective hood.

The at least one type of connector apparatus on the inner sealing gasket portion may be a gasket tab, and the at least one type of connecting device on the outer flexible gasket portion may include snaps, buttons, buckles, rivets, hooks and loop connectors, or combinations thereof.

It should be appreciated that all combinations of the foregoing concepts and additional concepts discussed in greater detail below (provided such concepts are not mutually inconsistent) are contemplated as being part of the inventive subject matter disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed inventive subject matter and, together with the general description given above and detailed description given below, serve to explain the principles of the disclosed subject matter, and wherein:

FIG. 1A is a front view of a first prior art face piece (e.g., Scott V-2000) compatible with the disclosed gasket apparatus;

FIG. 1B is an exploded view of the face piece of FIG. 1;

FIG. 2A is a front view of a second prior art face piece (e.g., Scott V-3000) compatible with the disclosed gasket apparatus;

FIG. 2B is an exploded view of the face piece of FIG. 2A;

FIG. 3 is a front view of an example implementation of the disclosed gasket apparatus;

FIG. 4 is a rear view of the gasket apparatus of FIG. 3, wherein the gasket apparatus includes an inner gasket portion configured to form an airtight seal with a human face, and an outer gasket portion formed partially or completely around the inner gasket portion;

FIG. 5 is a rear perspective view of the gasket apparatus of FIG. 4 showing an interstitial space formed between the inner gasket portion and the outer gasket portion;

FIG. 6 is an exploded view of a non-limiting head piece comprising the gasket apparatus of FIG. 5, a face mask, a head net, and a protective hood or similar item;

FIG. 7 depicts the exemplary protective hood or similar item of FIG. 6 coupled to the disclosed gasket apparatus, wherein a portion of the exemplary protective hood connects to the outer gasket portion within the interstitial space without disrupting the airtight seal formed by the inner gasket portion; and

FIG. 8 is a cross-sectional side view of FIG. 7 showing the portion of the exemplary protective hood connected to the outer gasket portion within the interstitial space, and further showing the exemplary head net of FIG. 6 coupled to one or more tabs extending from the inner gasket portion of the disclosed gasket apparatus.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed inventive subject matter. Accordingly, the following implementations are set forth without any loss of generality to, and without imposing limitations upon, the claimed subject matter.

Various implementations of the disclosed systems and apparatuses provide face pieces or masks for use with SCBA systems that include structural features for attaching protective items near the sealing portion of the face mask without negatively affecting the quality of the seal formed between the face mask and face of the wearer of the SCBA system. These structural features are embodied in an improved gasket apparatus that includes an inner sealing gasket portion, an outer gasket portion, and an interstitial space formed between the inner sealing gasket portion and the outer gasket portion. The interstitial space receives a portion of the protective item therein when the protective item is connected or mounted to the outer gasket portion of the gasket apparatus. For context, the design and construction of several existing face pieces used with SCBA systems are discussed below. The disclosed technology may be used with a wide variety of existing face pieces, including those shown in the drawings. Current manufacturers of such face pieces include, for example, Scott, Honeywell, MSA, and Draeger. The face masks manufactured by these and other entities may be manufactured to initially include the disclosed gasket apparatus, or such face masks may be retrofitted with the disclosed gasket apparatus. The disclosed gasket apparatus is compatible with the fire protective headgear disclosed in U.S. Pat. No. 10,603,526, which is incorporated by reference herein, in its entirety, for all purposes.

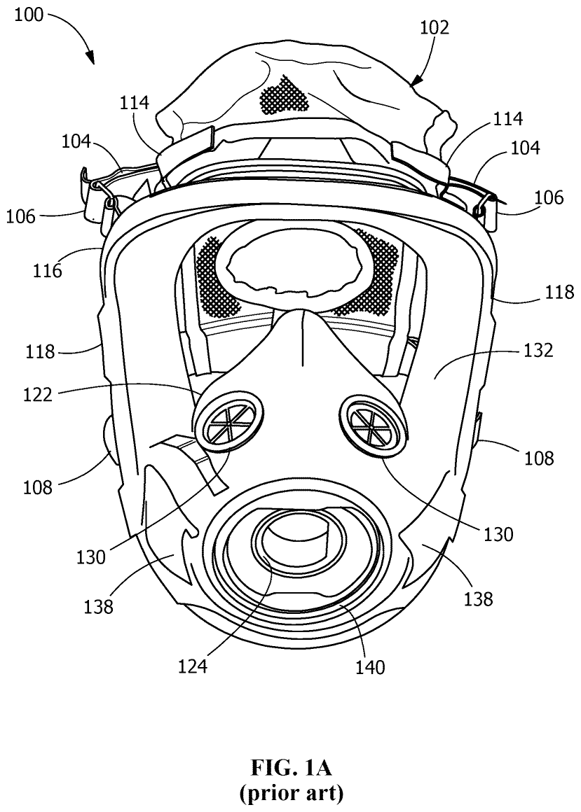

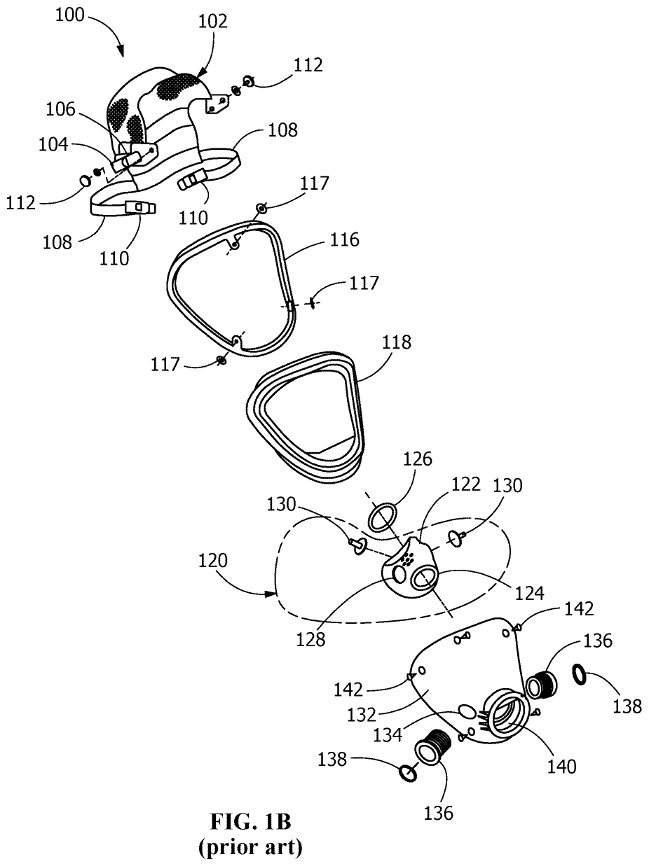

FIGS. 1A-1B depict a first prior art face piece (e.g., Scott V-2000) compatible with the disclosed apparatus, wherein FIG. 1A is a front view of the assembled face piece and FIG. 1B is an exploded view of the face piece. With reference to FIGS. 1A-1B, face piece 100 includes head harness assembly 102 that further includes two temple straps 104, two temple strap buckles 106, two neck straps 108, two neck strap buckles 110, two connector assemblies 112, and two Velcro straps 114. Lens frame 116 surrounds face sealing gasket 118 when face piece 100 is assembled. Nose cup assembly 120 is disposed within face sealing gasket 118 and includes nose cup 122, gas inlet 124, sealing O-ring 126, two inhalation valve apertures 128, and two inhalation valves 130. Face piece lens 132 mounts against and within face sealing gasket 118 and is secured in place by lens frame 116 using connectors 117 and 142. Face piece lens 132 includes two voicemitter apertures 134, two voicemitter ducts 136 mounted within apertures 134, two voicemitters 138 mounted within ducts 136, and gas inlet 140.

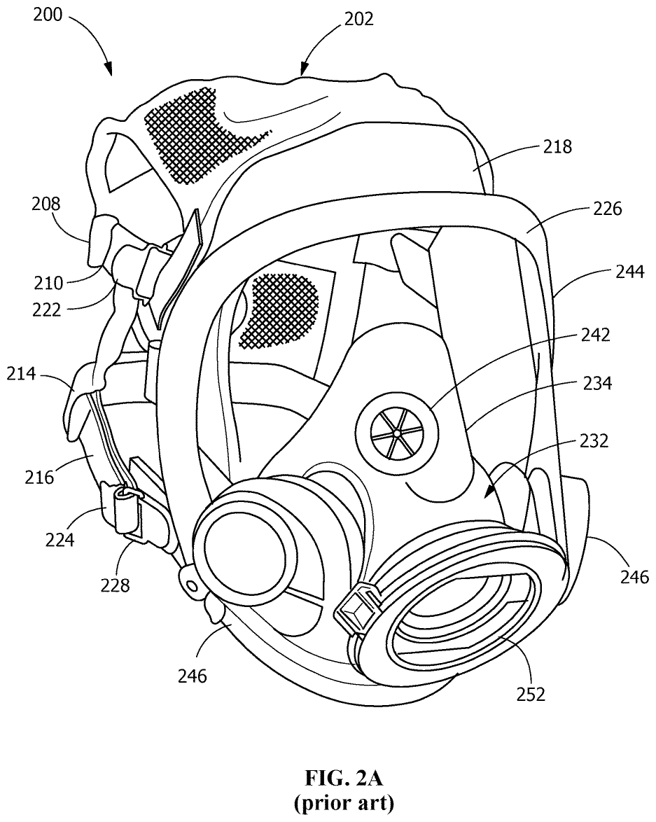

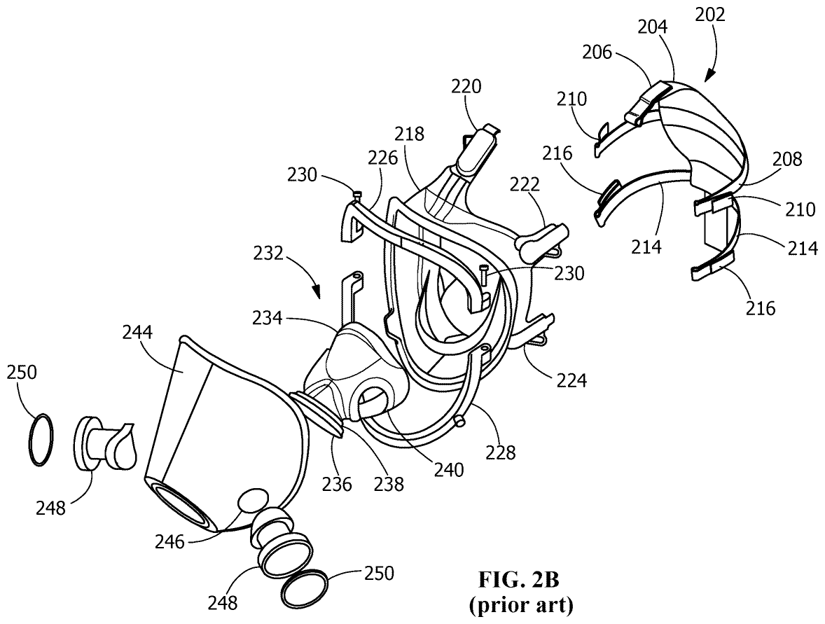

FIGS. 2A-2B depict a second prior art face piece (e.g., Scott V-3000) compatible with the disclosed apparatus, wherein FIG. 2A is a front perspective view of the assembled face piece and FIG. 2B is an exploded view of the face piece. With reference to FIGS. 2A-2B, head harness assembly 202 includes strap connector 206, temple straps 208, temple strap connectors 210, neck straps 214, and neck strap connectors 216. Face sealing gasket 218 includes forehead buckle 220, which engages forehead strap connector 206, two temple buckles 222, which engage temple strap connectors 210, and two neck buckles 224, which engage neck strap connectors 216. Upper lens frame 226 and lower lens frame 228, which surround face sealing gasket 218 when face piece 200 is assembled are connected to one another using frame screws 230. Nose cup assembly 232 is disposed within face sealing gasket 218 and includes nose cup 234, gas inlet 236, O-ring 238, two inhalation valve apertures 240, and two inhalation valves 242. Face piece lens 244 mounts against and within face sealing gasket 218 and is secured in place by upper lens frame 226 and lower lens frame 228. Face piece lens 244 includes two voicemitter apertures 246, two voicemitter ducts 248 mounted within apertures 246, and two voicemitters 250 mounted within ducts 248, and gas inlet 252.

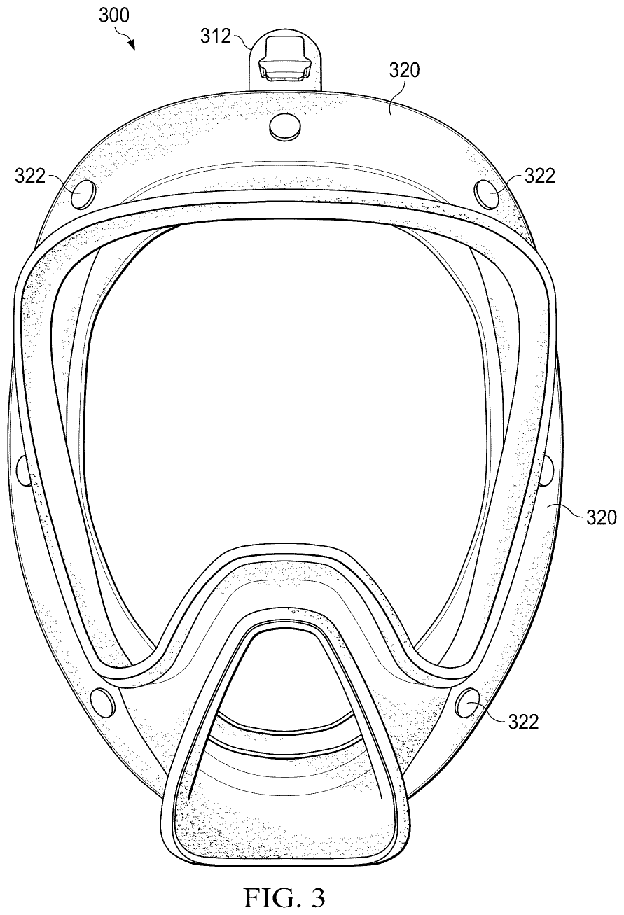

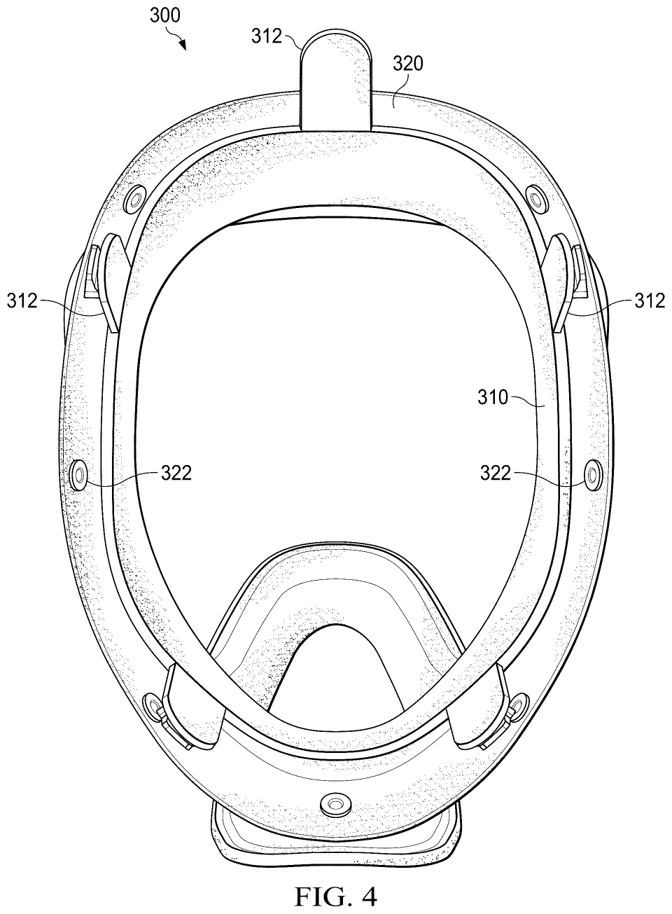

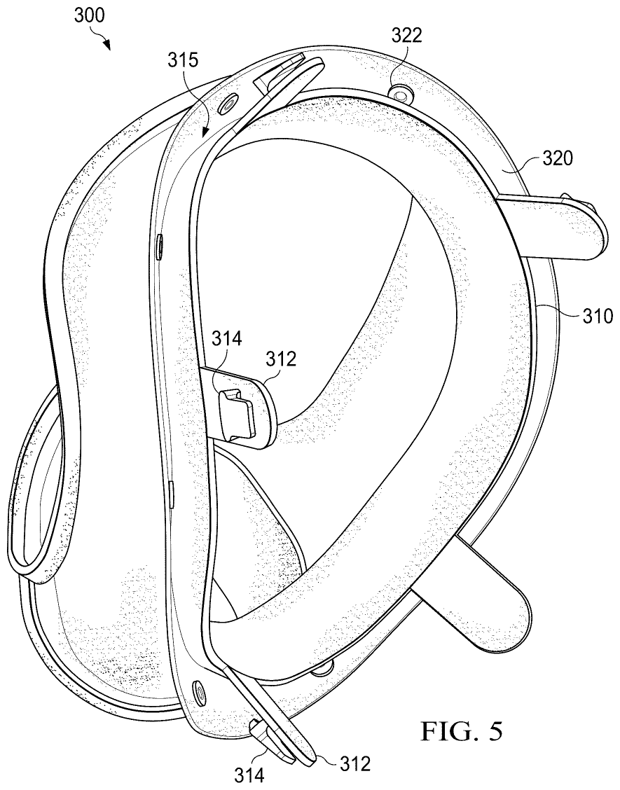

FIG. 3 is a front view of an example implementation of the disclosed gasket apparatus; FIG. 4 is a rear view of the gasket apparatus of FIG. 3, wherein the gasket apparatus includes an inner gasket portion configured to form an airtight seal with a human face, and an outer gasket portion formed partially or completely around the inner gasket portion; and FIG. 5 is a rear perspective view of the gasket apparatus of FIG. 4 showing an interstitial space formed between the inner gasket portion and the outer gasket portion.

With reference to FIGS. 3-5, gasket apparatus 300 includes inner gasket portion 310 and outer gasket portion 320. Outer gasket portion 320 partially or fully surrounds inner gasket portion 310 and is typically formed integrally therewith (i.e., as a single or unitary gasket apparatus) for providing additional surface area to the existing mask flange. Inner gasket portion 310 and outer gasket portion 320 define interstitial space or gap 315 formed therebetween (see FIG. 5). As will be discussed in greater detail below, interstitial space 315 receives a portion of a protective hood or similar protective item therein when the protective item is connected or mounted to outer gasket portion 320.

In some non-limiting implementations, interstitial space 315 is substantially V-shaped to securely retain the portion of the protective hood therein. Gasket apparatus 300 may be manufactured from flexible rubber, elastomer, or any other suitably pliable material using injection molding or any other suitable manufacturing process.

Still referring to FIGS. 3-5, inner gasket portion 310 includes one or more inner gasket tabs 312 or similar connectors formed on or attached to its outer surface, each of which include flange 314. Inner gasket portion 310 surrounds and forms a seal with the face of the user, which acts as a substrate for inner gasket 310. Inner gasket tabs 312 and flanges 314 may be used to attach a head net or head harness assembly (similar to item 202 shown in FIG. 2B) to the outer surface of inner gasket 310. Using inner gasket tabs 312 in this manner allows tension created by securing the head harness to inner gasket 310 to pull the inner surface of inner gasket 310 against the face of a user, thereby forming a more effective seal therewith.

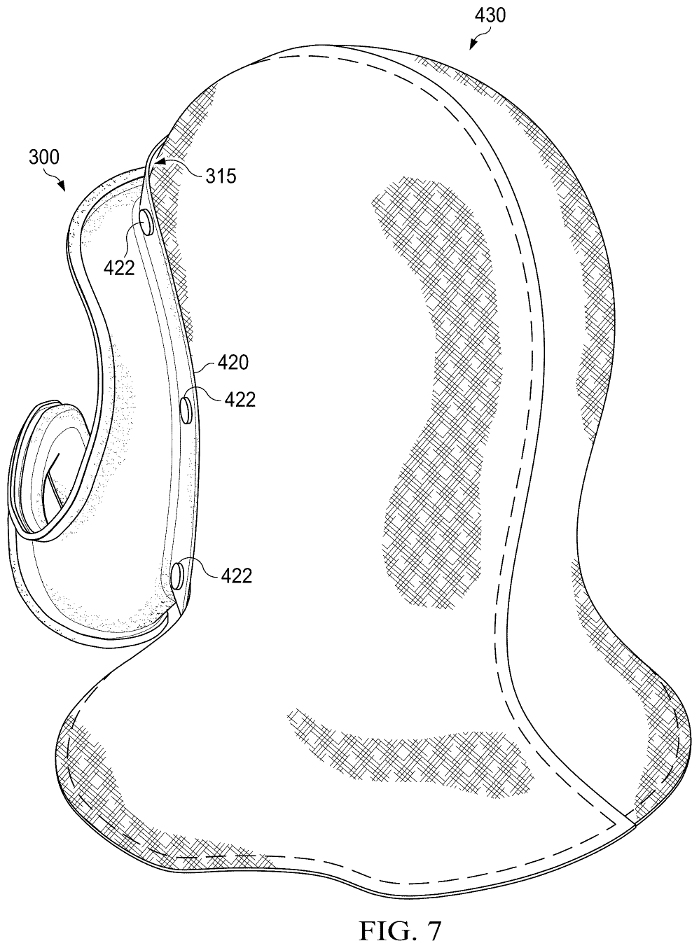

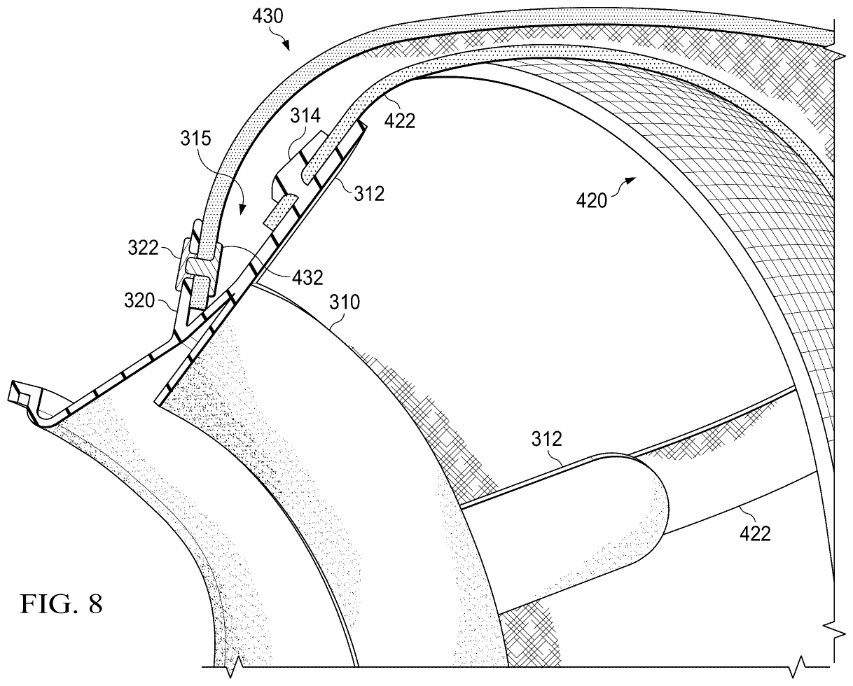

A plurality of connectors 322 are included on outer gasket portion 320 for connecting one or more protective items to outer gasket portion 320 without disrupting the airtight seal formed by inner gasket portion 310 against the face of the user. Suitable connectors may include snaps, buttons, buckles, rivets, hooks and loop connectors, or combinations thereof. In FIGS. 3-5, female snap connectors 322 are shown formed in the outer surface of outer gasket portion 320, with the snap component passing through the material of outer gasket portion 320 and the female end facing inward toward interstitial space 315. A fire-resistant hood, bio-hazard type hood, or helmet, head cover, other apparel which has corresponding connector components (e.g., the receiving portion of a snap) may be attached to connectors 322 such that the forward edge of the hood rests securely within interstitial space 315 (see FIGS. 7-8), thereby forming a highly effective closure and barrier between the user and the outer environment.

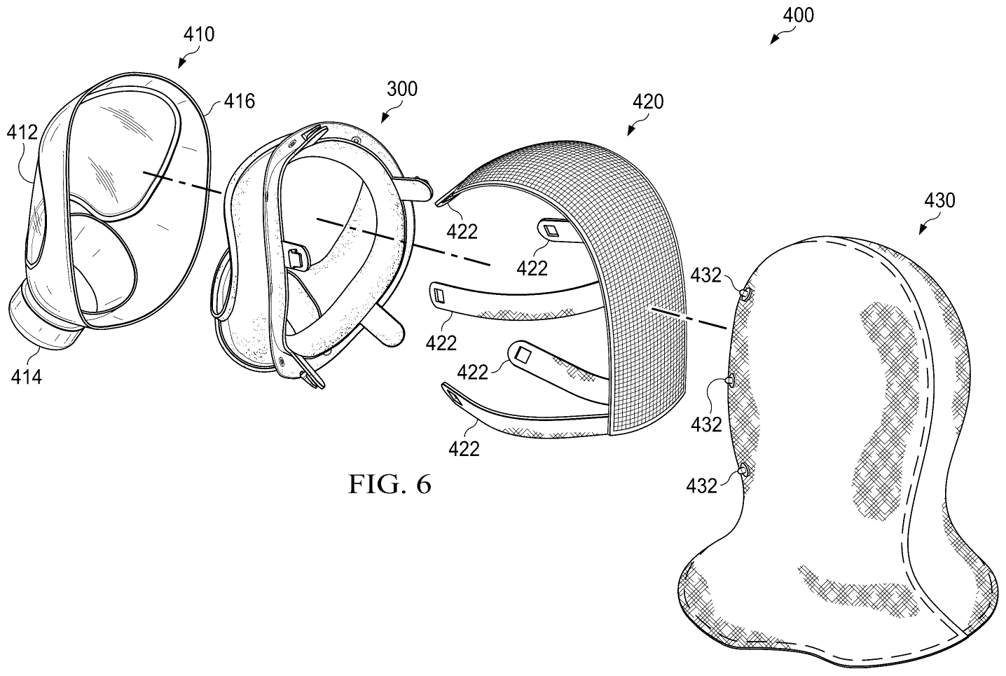

FIG. 6 is an exploded view of a non-limiting head piece assembly comprising the gasket apparatus of FIG. 5, a face mask, a head net, and a protective hood or similar item; FIG. 7 depicts the exemplary protective hood or similar item of FIG. 6 coupled to the disclosed gasket apparatus, wherein a portion of the exemplary protective hood connects to the outer gasket portion within the interstitial space without disrupting the airtight seal formed by the inner gasket portion; and FIG. 8 is a cross-sectional side view of FIG. 7 showing the portion of the exemplary protective hood connected to the outer gasket portion within the interstitial space, and further showing the exemplary head net of FIG. 6 coupled to one or more tabs extending from the inner gasket portion of the disclosed gasket apparatus.

Now referring to FIGS. 6-8, the disclosed gasket apparatus 300 may be a component of head piece assembly 400. Head piece assembly 400 further comprises face mask 410, head net or head harness 420, and protective hood or similar item 430. When assembled, head net or head harness 420 is contained within protective hood or similar item 430. Face mask 410 includes clear visor 412, regulator connector 414, and rigid rim 416 that supports visor 412. When assembled, gasket apparatus 300 attaches to rim 416. Similar to item 202 shown in FIG. 2B, head net or head harness 420 includes a plurality of strap connectors 422 that correspond to and connect with inner gasket tabs 312 formed on or attached to the outer surface of inner gasket portion 310. As previously described, inner gasket tabs 312 allow tension created by securing head harness 420 to inner gasket 310 to pull the inner surface of inner gasket 310 against the face of a user, thereby forming a more effective seal therewith.

Protective hood or similar item 430 includes a plurality of connectors 432 that correspond to and connect with connectors 322 formed on outer gasket portion 320. Suitable connectors may include snaps, buttons, buckles, rivets, hooks and loop connectors, or combinations thereof. In FIGS. 6 and 8, male snap connectors 432 are shown formed on the outer surface of protective hood 430 at predetermined locations. Connectors 432 attach to connectors 322 such that the forward edge or portion of protective hood 430 rests securely within interstitial space 315, thereby forming a highly effective closure and barrier between the user and the outer environment (see FIG. 8). This closure acts in the manner of a zipper and forces air to travel inward in a zig-zag manner, thereby making air penetration into the interior of the face piece very difficult. Once hood 430 is attached to gasket apparatus 300 and head piece assembly 400 is fully assembled on the user, duct tape or other sealing tape may be applied over the outer edge of outer gasket 320 and the exposed front portion of hood 430 to create an additional barrier between the interior of face mask 410 and the outer potentially hazardous environment.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differs from or contradicts this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about” used throughout this specification are used to describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed inventive subject matter. Various functions and elements described herein may be partitioned differently from those shown without departing from the scope of the disclosed inventive subject matter. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the figures, only for facilitating description of the present invention and simplifying the description, rather than indicating or implying that the referred devices or elements must be in a particular orientation or constructed or operated in the particular orientation, and therefore they should not be construed as limiting the present invention. The terms “connected”, “mounted”, “fixed”, etc. should be understood in a broad sense. For example, “connected” may be a fixed connection, a detachable connection, or an integral connection; a direct connection, or an indirect connection through an intermediate medium. For an ordinary skilled in the art, the specific meaning of the above terms in the present invention may be understood according to specific circumstances.

It should be appreciated that all combinations of the foregoing concepts and additional concepts discussed in greater detail herein (provided such concepts are not mutually inconsistent) are contemplated as being part of the disclosed inventive subject matter. In particular, all combinations of claimed subject matter appearing at the end of this disclosure are contemplated as being part of the inventive subject matter disclosed herein. While the disclosed inventive subject matter has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed inventive subject matter in its broader aspects is not limited to any of the specific details, representative devices and methods, and/or illustrative examples shown and described. Accordingly, departures may be made from such details without departing from the spirit or scope of the general inventive concept.

What is claimed:

1. A gasket apparatus, comprising:
(a) an inner gasket portion configured to form an airtight seal with a substrate, wherein the substrate is a human face;
(b) an outer gasket portion formed partially or completely around the inner gasket portion; and
(c) an interstitial space formed between the inner gasket portion and the outer gasket portion, wherein the interstitial space is configured to receive a portion of a protective item therein.

2. The gasket apparatus of claim 1, wherein the outer gasket portion includes at least one type of connecting device thereon for connecting the portion of the protective item to the outer gasket portion within the interstitial space without disrupting the airtight seal formed by the inner gasket portion.

3. The gasket apparatus of claim 2, wherein the at least one type of connective device on the outer gasket portion includes snaps, buttons, buckles, rivets, hooks and loop connectors, or combinations thereof.

4. The gasket apparatus of claim 1, wherein the protective item includes a hood, a helmet, a head covering, or the like.

5. The gasket apparatus of claim 1, wherein the inner gasket portion and the outer gasket portion are formed integrally with one another from a single piece of material.

6. The gasket apparatus of claim 1, wherein the inner gasket portion includes at least one type of connector device formed thereon or attached thereto.

7. The gasket apparatus of claim 6, wherein the at least one type of connector apparatus on the inner gasket portion receives a head net or a head harness of the protective item.

8. The gasket apparatus of claim 6, wherein the at least one type of connector apparatus on the inner gasket portion is a gasket tab.

9. The gasket apparatus of claim 1, wherein the gasket apparatus is adapted for use with a self-contained breathing apparatus.

10. The gasket apparatus of claim 9, wherein the self-contained breathing apparatus is adapted for use in industrial environments, commercial environments, household environments, firefighting environments, biohazard environments, medical environments, or military environments.

11. The gasket apparatus of claim 1, wherein the interstitial space is substantially V-shaped.

12. A gasket apparatus, comprising:
(a) an inner sealing gasket portion configured to form an airtight seal with a substrate, wherein the substrate is a human face;
(b) an outer flexible gasket portion formed partially or completely around the inner sealing gasket portion, wherein the outer flexible gasket portion includes at least one type of connecting device thereon; and
(c) an interstitial space formed between the inner sealing gasket portion and the outer flexible gasket portion,
wherein the at least one type of connecting device connects one or more protective items to the outer flexible gasket portion within the interstitial space without disrupting the airtight seal formed by the inner sealing gasket portion.

13. The gasket apparatus of claim 12, wherein the at least one type of connective device on the outer flexible gasket portion includes snaps, buttons, buckles, rivets, hooks and loop connectors, or combinations thereof.

14. The gasket apparatus of claim 12, wherein the one or more protective items include a hood, a helmet, a head covering, or the like.

15. The gasket apparatus of claim 12, wherein the inner sealing gasket portion and the outer flexible gasket portion are formed integrally with one another from a single piece of material.

16. The gasket apparatus of claim 12, wherein the inner sealing gasket portion includes at least one gasket tab formed thereon or attached thereto, and wherein the at least one gasket tab receives a head net or a head harness of the one or more protective items.

17. The gasket apparatus of claim 12, wherein the gasket apparatus is adapted for use with a self-contained breathing apparatus, and wherein the self-contained breathing apparatus is adapted for use in industrial environments, commercial environments, household environments, firefighting environments, biohazard environments, medical environments, or military environments.

18. The gasket apparatus of claim 12, wherein the interstitial space is substantially V-shaped.

19. A gasket apparatus for use with a self-contained breathing system or apparatus, comprising:
(a) an inner sealing gasket portion configured to form an airtight seal with a substrate, wherein the substrate is a human face, and wherein the inner sealing gasket includes at least one type of connector apparatus formed thereon or attached thereto;
(b) an outer flexible gasket portion formed partially or completely around the inner sealing gasket portion, wherein the outer flexible gasket portion includes at least one type of connecting device thereon; and
(c) an interstitial space formed between the inner sealing gasket portion and the outer flexible gasket portion,
wherein the at least one type of connecting device connects a portion of a protective hood to the outer flexible gasket portion within the interstitial space without disrupting the airtight seal formed by the inner sealing gasket portion, and
wherein the at least one type of connector apparatus on the inner sealing gasket portion receives a head net or a head harness of the protective hood.

20. The gasket apparatus of claim 19, wherein the at least one type of connector apparatus on the inner sealing gasket portion is a gasket tab, and wherein the at least one type of connecting device on the outer flexible gasket portion includes snaps, buttons, buckles, rivets, hooks and loop connectors, or combinations thereof.
